(19) United States
(12) Patent Application Publication
(10) Pub. No.: US 2006/0206759 A1
(43) Pub. Date: Sep. 14, 2006

(54) Universal serial bus backup device

(76) Inventor: Yung-Chao Chih, Pingjhen City (TW)

Correspondence Address: SCHMEISER, OLSEN & WATTS, 22 CENTURY HILL DRIVE, SUITE 302, LATHAM, NY, 12110, US

(21) Appl. No.: 11/322,794

(22) Filed: Dec. 30, 2005

(30) Foreign Application Priority Data
Mar. 8, 2005 (TW) 094203578

(51) Int. Cl. G06F 11/00

(52) U.S. Cl. 714/14

(57) ABSTRACT

A universal serial bus (USB) backup device includes a computer host having a backup application installed therein, and a USB bridging having a push button provided thereon. The USB bridging is internally provided with a virtual storage device. As a result, it is not necessary to connect a storage device to an output of the USB bridging, and the backup data in the computer host may be stored in other storage devices located at specified paths.

### FIELD OF THE INVENTION

The present invention relates to a USB backup device, with which it is not necessary to connect a storage device to an output of a USB bridging, and backup data in a computer host can be stored in other storage devices at specified paths.

### BACKGROUND OF THE INVENTION

Most computer users use the computer to perform data management. A user would have serious and irretrievable loss in the event the large amount of laboriously established data is invaded by hackers and viruses. To ensure the safety of the data stored in the computer, most computer users would periodically backup the data to establish backup files. For a personal user, a simple backup application (AP) is normally used to backup data. That is, to backup data, a backup application is installed in the computer host, and a USB bridging is connected to a USB socket provided on the computer host. The USB bridging has a push button provided thereon. A hard disk for storing the backup data must be then externally connected to an output of the USB bridging. When the computer is started, the operating system thereof would first detect whether an external hard disk is connected to the USB bridging. If the operating system detects there is not any hard disk connected to the USB bridging, the operating system automatically removes the USB bridging from the computer system. Or, if an external hard disk connected to the USB bridging is detected, the backup application is ready for backup of data. When the push button on the USB bridging is depressed, the backup application automatically proceeds with backup of data stored in the hard disk in the computer host and stores the backup data to the external hard disk. However, with the above-mentioned simply backup device, the data in the hard disk in the computer host is backed up and stored in the external hard disk via a low-speed USB inter-face. This manner of backing up data is not suitable for other high-speed transmission interfaces that require particular system driver and software to conduct backup in the above-described manner.

It is therefore tried by the inventor to develop a USB backup device, with which it is not necessary to connect a storage device to an output of a USB bridging, and backup data in a computer host can be stored in other storage devices at specified paths.

### SUMMARY OF THE INVENTION

A primary object of the present invention is to provide a USB backup device, with which it is not necessary to connect a storage device to an output of a USB bridging, and backup data in a computer host can be stored in other storage devices at specified paths.

To achieve the above and other objects, the USB backup device of the present invention includes a computer host having a backup application installed therein, and a USB bridging having a push button provided thereon. The USB bridging is internally provided with a virtual storage device. As a result, it is not necessary to connect a storage device to an output of the USB bridging, and the backup data in the computer host may be stored in other storage devices located at specified paths.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of the USB backup device of the present invention.

### DETAILED DESCRIPTION OF THE PREFERRED EMBODIMENTS

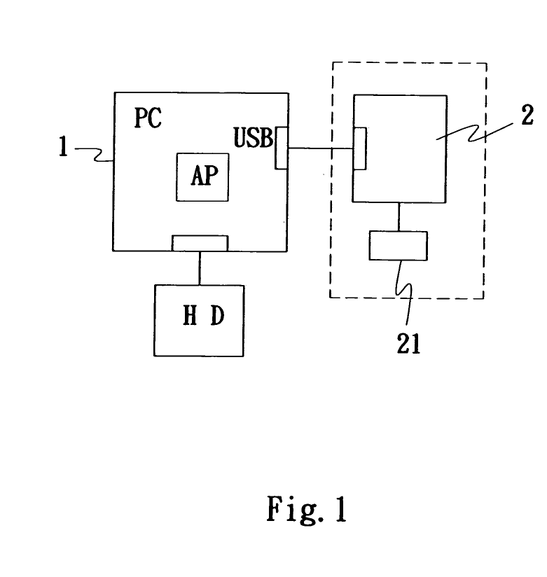

Please refer to FIG. 1 that is a block diagram of a USB backup device according to a preferred embodiment of the present invention. As shown, the USB backup device of the present invention includes a computer host 1 internally installed with a backup application, and a USB bridging 2 having a push button 21 provided thereon. Wherein, the USB bridging 2 is internally provided with a virtual storage device.

In the preferred embodiment of the present invention, the virtual storage device provided in the USB bridging 2 is a virtual hard disk. The virtual hard disk only allows an operating system to detect and read data from it, but not to write data into it. When the push button 21 is depressed, the backup application automatically detects the depression of the push button 21 and runs preset storing backup parameters, so that data stored in the storage device of the computer host 1 are separately stored in other different storages and/or memories, depending on the path of the backup application and settings of file type. Therefore, it is not necessary to connect a storage device to an output of the USB bridging 2, and the backup data in the computer host 1 may be stored in other storage devices at specified paths. Moreover, the USB backup device of the present invention can be driven using a default driver of a general operating system without the need of using a particular driver, and then uses the standard USB interface to actuate the backup via other high-speed transmission interface. In this manner, it is possible to reduce the problems of after service and compatibility.

What is claimed is:

1. A universal serial bus (USB) backup device, comprising a computer host having a backup application installed therein, and a USB bridging having a push button provided thereon; and wherein said USB bridging is internally provided with a virtual storage device.
